(19) United States
(12) Patent Application Publication
(10) Pub. No.: US 2005/0050187 A1
(43) Pub. Date: Mar. 3, 2005

(54) Method and apparatus for support of bottleneck avoidance in an intelligent adapter

(75) Inventors: Douglas Morgan Freimuth, New York, NY (US); Ronald Mraz, South Salem, NY (US); Erich Nahum, New York, NY (US); Prashant Pradhan, New Rochelle, NY (US); Sambit Sahu, Mahopac, NY (US); John Michael Tracey, Scarsdale, NY (US)

Correspondence Address: DUKE. W. YEE, YEE & ASSOCIATES, P.C., P.O. BOX 802333, DALLAS, TX, 75380, US

(73) Assignee: International Business Machines Corporation, Armonk, NY (US)

(21) Appl. No.: 10/654,069

(22) Filed: Sep. 3, 2003

(51) Int. Cl. G06F 15/173

(52) U.S. Cl. 709/223

(57) ABSTRACT

A mechanism for bottleneck avoidance is provided in an intelligent adapter. The mechanism allows the adapter to be used such that host/adapter system throughput is optimized. The bottleneck avoidance mechanism of the present invention determines when the adapter becomes a bottleneck. If certain conditions exist, then new connections are refused so that the adapter can process packets for existing connections. If certain other conditions exist, the adapter may migrate workload to the host processor for processing. These conditions may be determined by comparing memory usage or central processing unit usage to predetermined thresholds. Alternatively, the conditions may be determined by comparing adapter response time to host response time.

### BACKGROUND OF THE INVENTION

1. Technical Field

The present invention relates to data processing systems and, in particular, to intelligent adapters. Still more particularly, the present invention provides a method and apparatus for support of bottleneck avoidance on an intelligent adapter.

2. Description of Related Art

A controller may be defined as a device that controls the transfer of data from a computer to a peripheral device and vice versa. For example, disk drives, display screens, keyboards, and printers all require controllers. In personal computers, the controllers are often single chips. A computer typically comes with all the necessary controllers for standard components, such as the display screen, keyboard, and disk drives. New controllers may be added by inserting expansion cards. A common example of a controller is a network adapter or network interface card (NIC).

An intelligent controller may be defined as a peripheral control unit that uses a built-in microprocessor for controlling its operation. An intelligent controller may then process information using its built-in microprocessor that would normally be processed by the host computer's processor. For example, an intelligent network adapter may process network connections and packets using the network adapter's processor. This relieves some of the burden on the host computer's processor and improves efficiency of the data processing system as a whole.

However, network adapters generally have a different architecture and/or resources compared to the host processor. If such an adapter is used for network processing without accounting for these differences, then the adapter can become a processing bottleneck and degrade the overall performance of the system. There is no known solution to this problem at the controller level.

Therefore, it would be advantageous to provide an improved mechanism for bottleneck avoidance in an intelligent adapter.

### SUMMARY OF THE INVENTION

The present invention provides a mechanism for bottleneck avoidance in an intelligent adapter and in network interfaces in general. The present invention allows the adapter to be used such that host/adapter system throughput is optimized. The bottleneck avoidance mechanism of the present invention determines when the adapter becomes a bottleneck. If certain conditions exist, then new connections are refused so that the adapter can process packets for existing connections. If certain other conditions exist, the adapter may migrate workload to the host processor for processing. These conditions may be determined by comparing memory usage or central processing unit usage to predetermined thresholds. Alternatively, the conditions may be determined by comparing adapter response time to host response time.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented in accordance with a preferred embodiment of the present invention;

FIG. 2 is a block diagram of a data processing system is shown in which the present invention may be implemented;

FIG. 3 is a block diagram illustrating a data processing system including an intelligent network adapter in accordance with a preferred embodiment of the present invention;

FIG. 4 is a flowchart illustrating a target metric method for accepting workload at an adapter in accordance with a preferred embodiment of the present invention;

FIG. 5 is a block diagram illustrating a compare metric bottleneck avoidance mechanism in accordance with a preferred embodiment of the present invention; and

FIG. 6 is a flowchart illustrating the operation of a compare metric method for accepting workload at an adapter in accordance with a preferred embodiment of the present invention.

### DETAILED DESCRIPTION OF THE PREFERRED EMBODIMENT

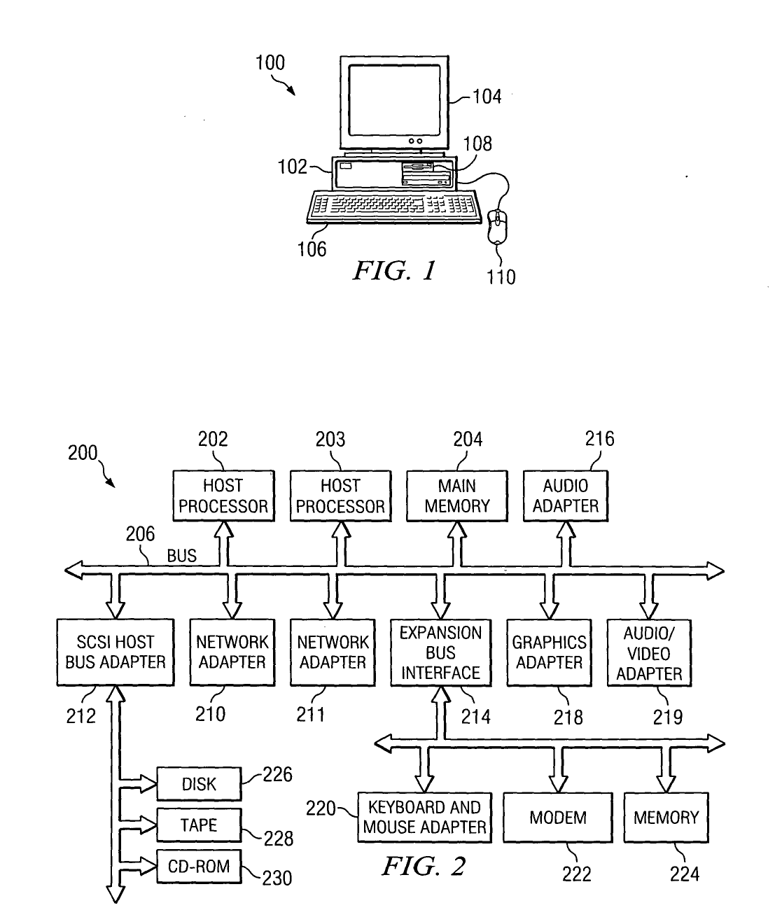

With reference now to the figures and in particular with reference to FIG. 1, a pictorial representation of a data processing system in which the present invention may be implemented is depicted in accordance with a preferred embodiment of the present invention. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like.

Computer 100 can be implemented using any suitable computer, such as an IBM eServer computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 may be a server in a preferred embodiment of the present invention.

Data processing system 200 may employ a peripheral component interconnect (PCI) local bus architecture. Although the depicted example employs a PCI bus, other bus architectures such as Accelerated Graphics Port (AGP) and Industry Standard Architecture (ISA) may be used. Host processors 202, 203 and main memory 204 are connected to PCI local bus 206. In the depicted example, data processing system 200 includes two host processors; however, more or fewer host processors may be used depending upon the implementation. PCI bridge 208 also may include an integrated memory controller and cache memory for processor 202. Additional connections to PCI local bus 206 may be made through direct component interconnection or through add-in boards.

In the depicted example, network adapters 210, 211, small computer system interface SCSI host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors. In the depicted example, data processing system 200 includes two network adapters; however, more or fewer network adapters may be used within the scope of the present invention.

An operating system runs on host processors 202, 203 and is used to coordinate and provide control of various components within data processing system 200 in FIG. 2. The operating system may be a commercially available operating system such as Linux, AIX from IBM Corporation, Sun Solaris, or Windows XP, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by host processors 202, 203.

Those of ordinary skill in the art will appreciate that the hardware in FIG. 2 may vary depending on the implementation. Other internal hardware or peripheral devices, such as flash read-only memory (ROM), equivalent nonvolatile memory, or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230. In that case, the computer, to be properly called a client computer, includes some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide non-volatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance.

In a preferred embodiment of the present invention, network adapters 210, 211 are intelligent adapters. A mechanism for bottleneck avoidance is provided in network adapter 210, for example. The present invention allows the adapter to be used such that host/adapter system throughput is optimized. The bottleneck avoidance mechanism of the present invention determines when adapter 210, for instance, becomes a bottleneck. If certain conditions exist, then new connections are refused so that the adapter can process packets for existing connections. If certain other conditions exist, the adapter may migrate workload to one of host processors 202, 203 for processing. These conditions may be determined by comparing memory usage or central processing unit usage to predetermined thresholds. Alternatively, the conditions may be determined by comparing adapter response time to host response time.

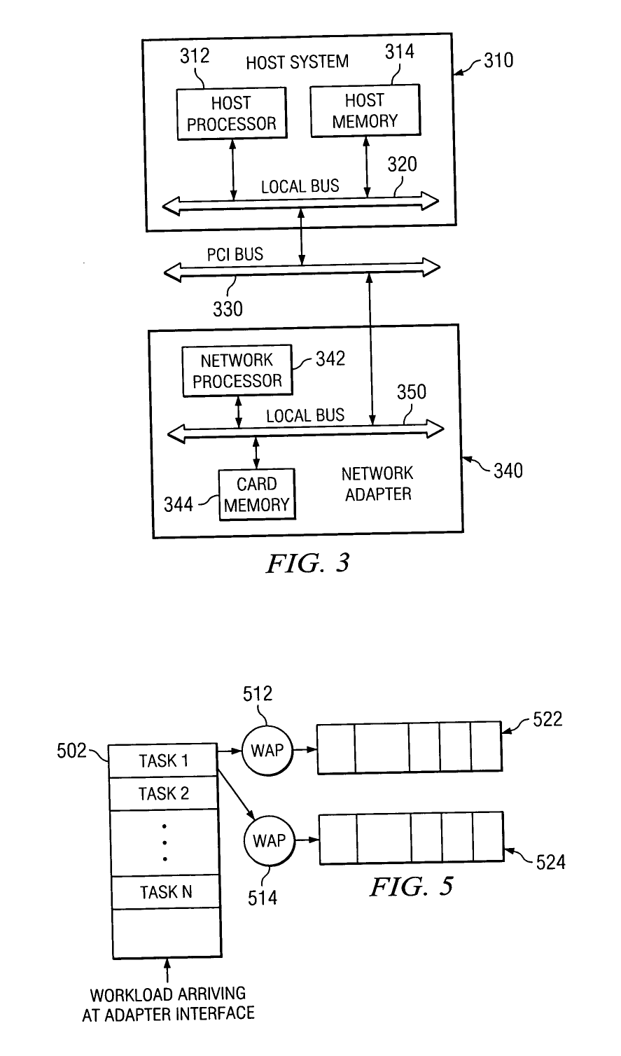

With reference now to FIG. 3, a block diagram illustrating a data processing system including an intelligent network adapter is shown in accordance with a preferred embodiment of the present invention. Host system 310 employs a peripheral component interconnect (PCI) bus architecture, although other bus architectures such as Accelerated Graphics Port (AGP) and Industry Standard Architecture (ISA) may be used. Host processor 312 and main memory 314 are connected to PCI bus 330 through local bus 320.

Additional connections to PCI bus 330 may be made through direct component interconnection or through add-in boards. For example, network adapter 340 is connected to PCI bus 330. Network processor 342 and card memory 344 are connected to local bus 350. Network processor 342 may perform network processing to relieve the burden of host processor 312. Many tasks, such as packet processing, that take place in the network protocol layer of host system 310 are performed on the network adapter.

In a preferred embodiment of the present invention, network adapter 340 includes a bottleneck avoidance mechanism. First, the mechanism determines when the adapter becomes a bottleneck and then provides mechanisms to prevent such a state when full offload of network processing is used. The adapter may also perform partial offload of network protocol processing. Thus, the mechanism of the present invention prevents the adapter from becoming a bottleneck in this mode of operation as well. An objective of the present invention is to limit the amount of work that the adapter handles beyond which it could potentially be overloaded. However, the workload could vary from connection to connection.

1. Workload Characterization and Bottleneck Condition

One must first define what constitutes a workload and assumptions with regard to network processing offload. The unit of workload can be defined at any granularity, e.g., at connection level, packet level, or for any subset of processing as one unit of workload. In accordance with a preferred embodiment, connection level is considered to be the granularity of workload, i.e., the process of connection establishment, data transfer/access, and connection tear down constitute the life cycle of typical network processing.

Furthermore, when the entire network processing is done at the adapter rather than at the host, this is defined as full offload. During bottleneck conditions, the mechanism of the present invention provides the option to process connections on the host, if necessary. Two specific methods for determining bottleneck conditions are described herein, namely target metric and compare metric. The target metric method is mainly concerned with the performance of the adapter for scheduling the workload, thus it has reduced complexity. Compare metric optimizes the utilization of the host/adapter system by examining the performance of both. However, the compare metric method increases the complexity of the design.

1.1. Target Metric Objective

The first method is defined as the target metric objective. One purpose of an intelligent network adapter is to reduce the network processing overhead at the host while maintaining or improving throughput of host operations. In accordance with one embodiment of the present invention, the workload assigned to the adapter may be limited to a threshold so that the processing time at the adapter does not become too large. Note that, given the limited processing power and memory at the adapter, it is possible to show that the completion time is a function of adapter central processing unit (CPU) utilization and memory utilization. In other words, the goal is to determine the workload assignment for the adapter such that its CPU utilization and memory utilization remain below predetermined thresholds.

1.2. Compare Metric Objective

The second method is defined as compare metric. In this method, the adapter may be defined to be the bottleneck when the metric demonstrates that the adapter is performing worse compared to the host. The metric could be completion time of a connection, CPU utilization, memory utilization, or the like. The network processing is split between the adapter and the host such that the difference in the metric in these two resources is within a predefined boundary.

2. Bottleneck Avoidance with Target Metric Objective

As described above, target metric is a function of CPU utilization and memory utilization of the adapter. The target metric for CPU utilization consists of two thresholds: U_{low} and U_{high}. The target metric for memory utilization consists of one threshold Mₜ. The adapter keeps track of the CPU utilization and memory utilization using an averaging algorithm such as exponential weighted average.

As a basis of the target metric algorithm, the bottleneck avoidance mechanism of the present invention distinguishes between the workload from a new connection that has not yet been accepted and the workload from existing connections. If there is not enough memory, Mₜ, then the new connection is not accepted. If there is enough memory available, the lower threshold, U_{low}, on the CPU utilization is used to decide whether to accept a new connection. The higher threshold, U_{high}, on the adapter CPU utilization is used to decide whether the workload from the already accepted connections is overloading the adapter. This threshold is used to identify when it is necessary migrate accepted connections to the host.

Exceeding U_{high} may occur if the workload from accepted connections exceed the expected amount of work and, thus, overload the adapter CPU. Connection migration refers to a procedure for moving the accepted connection to the host and reestablish its state to resume its processing requirements using the host processor. In this process, a decision has to be made as to which connections are to be selected for the migration process. While it is possible to use any policy to decide the candidates for migration, a last-in-first-out (LIFO) order is proposed as a preferred embodiment for selecting the connections. Under LIFO, a connection that has been accepted most recently would be the first candidate for migration.

2.1. Target Metric Algorithm Details

The bottleneck avoidance mechanism using a target metric algorithm updates memory utilization and CPU utilization measurements periodically, such as every few seconds. Upon arrival of workload, the bottleneck avoidance mechanism determines whether to accept new workload based on memory utilization and CPU utilization metrics. Furthermore, the bottleneck avoidance mechanism of the present invention also determines whether to migrate workload from the adapter to the host based on the CPU utilization metric.

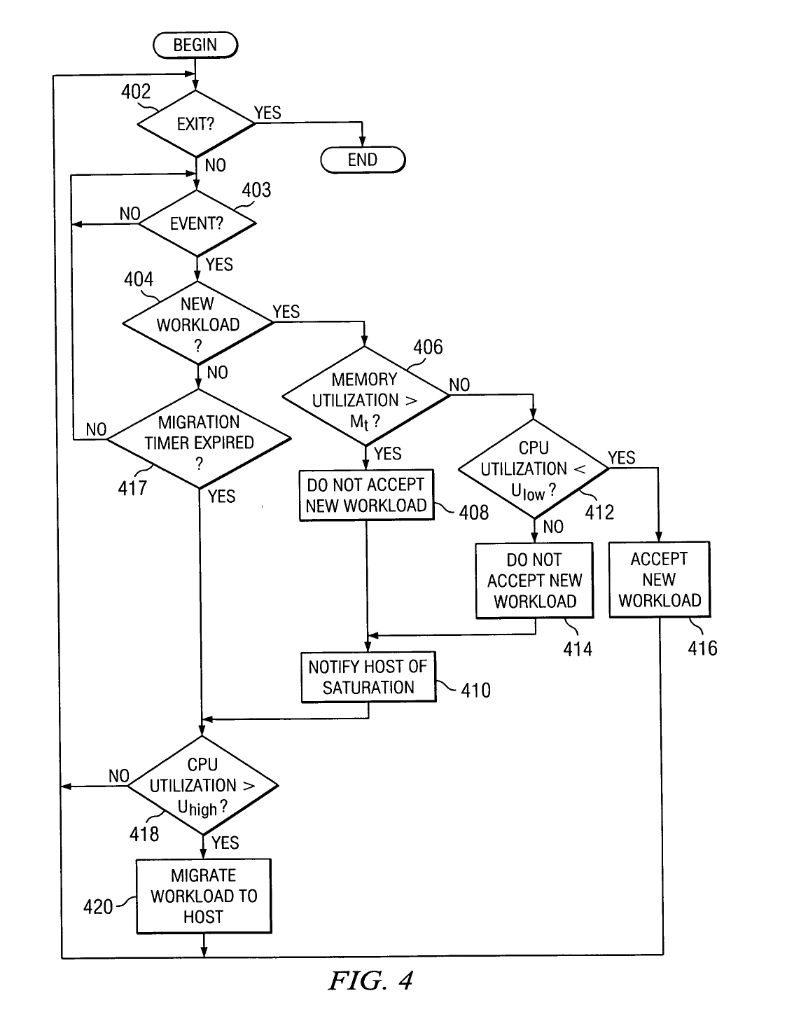

FIG. 4 is a flowchart illustrating a target metric method for accepting workload at an adapter in accordance with a preferred embodiment of the present invention. The process begins and a determination is made as to whether an exit condition exists (block 402). An exit condition may exist, for example, when the network adapter is shut down or taken offline. If an exit condition exists, the process ends. If an exit condition does not exist in block 402, a determination is made as to whether an event is received (block 403). If an event is not received, the process repeats block 403 until an event is received.

If an event is received, a determination is made as to whether new workload is received at the adapter interface (block 404). If new workload is received, a determination is made as to whether memory utilization is greater than a first predetermined threshold, Mₜ (block 406). If memory utilization is greater than Mₜ, then the adapter memory is saturated and the new workload is not accepted by the adapter (block 408). The adapter then notifies the host of memory saturation (block 410) and the process returns to block 418 to see if there is a need for connection migration.

If memory utilization does not exceed the first predetermined threshold in block 406, then a determination is made as to whether CPU utilization is greater than a second predetermined threshold, U_{low} (block 412). If CPU utilization exceeds the second predetermined threshold, the new workload is not accepted by the adapter (block 414) and the process returns to block 410 to notify the host that adapter has saturated. Next a transition is made to block 418 to check whether there is a need for connection migration. If, however, CPU utilization does not exceed U_{low} in block 412, the new workload is accepted by the adapter (block 416) and the process returns to block 402 to determine whether an exit condition exists.

Returning to block 404, if new workload is not received at the adapter interface, then a determination is made as to whether a migration timer expires (block 417). Migration timer refers to a periodic soft timer that is set to check periodically whether there is a need for connection migration on expiry of this timer. If the migration timer does not expire, the process returns to block 403 to determine whether an event occurs. If the migration timer is expired in block 417, then a determination is made as to whether CPU utilization is greater than a third predetermined threshold, U_{high} (block 418). If CPU utilization does not exceed the third threshold, the process simply returns to block 402 to determine whether an exit condition exists. However, if CPU utilization does exceed U_{high} in block 418, the process migrates workload from the adapter to the host (block 420). Thereafter, the process returns to block 402 to determine whether an exit condition exists.

The above described flowchart uses a connection migration algorithm from the adapter to the host. This migration algorithm depends on specified policies to decide which connections should be migrated to the host when CPU utilization exceeds U_{high}. One possible approach for connection migration could be to remove connections in the reverse order of connection establishment time; however, other approaches may be used as will be recognized by a person of ordinary skill in the art.

2.2. Proposed APIs

In accordance with a preferred embodiment, two application program interfaces (APIs) may be provided to implement the above flowchart. The first API may notify the host when the adapter cannot accept any new connections. The second API allows the adapter to migrate connection processing to the host. In addition, the adapter requires the mechanism to sample the CPU and memory utilization periodically.

2.3. Extensions to the Preferred Embodiment

Several modifications may be made to the above target metric mechanism. For example, one may use more than two thresholds for the CPU utilization or more than one threshold for memory utilization. Furthermore, the mechanism may not deterministically discard workload after a certain threshold is reached. As another example, one could use various levels of threshold and drop workload proactively using some probability distribution function.

3. Bottleneck Avoidance with Compare Metric

The compare metric method compares an average completion time of a connection for the adapter with an average completion time of a connection for the host. Other metrics are also possible and the present invention is not restricted to the metric defined above. In this case, an adapter is considered as the bottleneck when it takes more time to complete the network processing compared to the host. In order to avoid such a condition, it is required that workload is split among the adapter and host equally such that average completion time is balanced between these two resources.

FIG. 5 is a block diagram illustrating a bottleneck avoidance mechanism in accordance with a preferred embodiment of the present invention. Workload arrives at the adapter interface. As illustrated in the depicted example, all the arriving packets/connections that need network processing are queued in workload wait queue (WWQ) 502 in the adapter. Both the adapter and host each have a working process denoted as work accept process (WAP) that have access to this WWQ. WAP 512 for the host receives a task from WWQ 502 and enqueues the task in the corresponding work accept queue (WAQ) 522, also associated with the host. Similarly, WAP 514 for the adapter receives a task from the WWQ and enqueues the task in the corresponding WAQ 524 for the adapter. A job in the WWQ is picked up by that WAP that has lower average completion time.

It is straightforward to maintain the average completion time at the adapter, as the adapter has the explicit knowledge about the completion time. It is more difficult to estimate at the adapter the response time of a task executed on the host without explicit messages indicating the completion time. One solution is to require such explicit notification. In a preferred embodiment of the present invention, the host indicates to the adapter when a connection is completed.

An alternative approach requires knowledge of the number of outstanding connections at the host. Given this information, the adapter may record every time a connection request is enqueued into the WAQ of the host. Let e₁, e₂, e₃, etc. denote the enqueuing time for job 1,2,3, . . . respectively. The adapter may also record every time a connection request is pulled out of this queue by the host for processing. Let these time instances be denoted as 1₁, 1₂, 1₃, . . . , 1₁₊ₖ, 1₂₊ₖ, 1₃₊ₖ, . . . etc. The average completion time of n connections at the host is approximated as:

$${RT}_{n} = \frac{{\sum }_{i}^{} {l}_{i + k} - \sum {e}_{i}}{n}$$

When the difference between the average completion time in the two resources exceeds a threshold, connection migration is invoked. The resource that has higher average completion time migrates connection based on some pre-specified policies.
3.1. Compare Metric Algorithm Details

The bottleneck avoidance mechanism using a compare metric algorithm updates response time RT upon completion of each job or task. Upon arrival of workload, the bottleneck avoidance mechanism determines whether to accept new workload based on whether the average response time for the adapter, RT_{adapter}, is greater than the average response time for the host, RTₕₒₛₜ. Furthermore, the bottleneck avoidance mechanism of the present invention may also determine whether to migrate workload from the adapter to the host based on whether the response time of the adapter exceeds the response time of the host by a predetermined threshold.

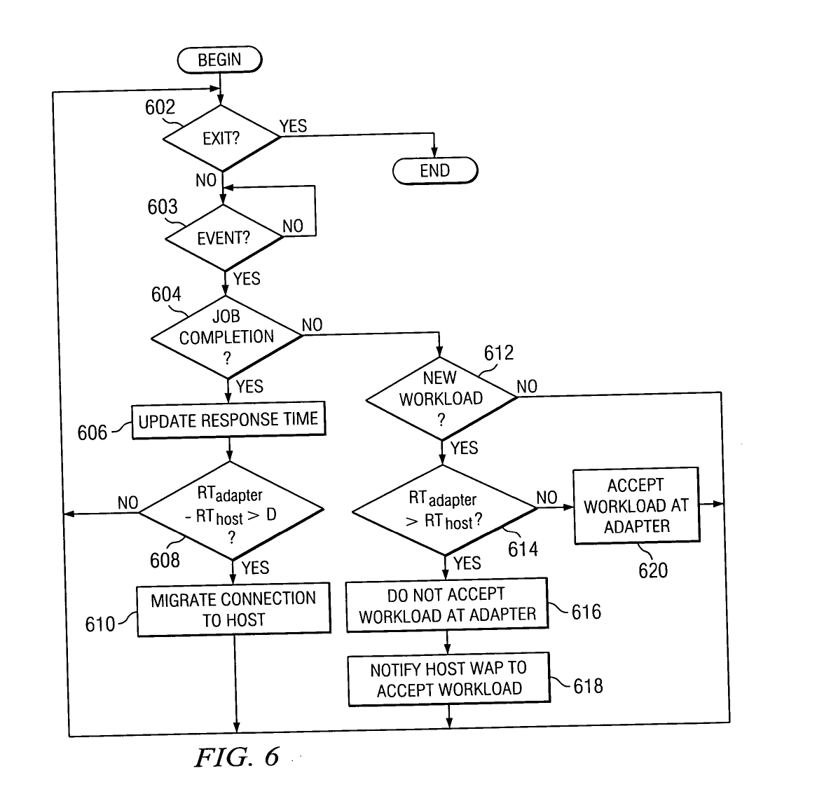

FIG. 6 is a flowchart illustrating the operation of a compare metric method for accepting workload at an adapter in accordance with a preferred embodiment of the present invention. The process begins and a determination is made as to whether an exit condition exists (block 602). An exit condition may exist, for example, when the network adapter is shut down or taken offline. If an exit condition exists, the process ends. If an exit condition does not exist in block 602, a determination is made as to whether an event is received (block 603). If an event is not received, the process repeats block 603 until an event is received.

If an event is received, a determination is made as to whether a job completion is received (block 604). If a job completion is received, the process updates the response time (block 606). If the job completion is from the host, the process updates the host response time. Similarly, if the job completion is from the adapter, the process updates the adapter response time. Then, a determination is made as to whether the response time for the adapter, RT_{adapter}, exceeds the response time of the host, RTₕₒₛₜ, by a predetermined threshold, D (block 608). If the response time of the adapter does not exceed the response time of the host by the predetermined threshold, the process returns to block 602 to determine whether an exit condition exists. However, if RT_{adapter}−RTₕₒₛₜ>D in block 608, then the process migrates workload to from the adapter to the host (block 610) and returns to block 602 to determine whether an exit condition exists. The process may continue to migrate workload to the host until the difference in response time falls below the predetermined threshold.

Returning to block 604, if a job completion is not received, a determination is made as to whether new workload is received at the adapter interface (block 612). If new workload is received, a determination is made as to whether the response time for the adapter, RT_{adapter}, is greater than the response time for the host, RTₕₒₛₜ (block 614). If the RT_{adapter} is greater than RTₕₒₛₜ, then the new workload is not accepted at the adapter (block 616) and notifies the host workload accept process (WAP) to accept the workload (block 618). Then, the process returns to block 602 to determine whether an exit condition exists. However, if RT_{adapter} is not greater than RTₕₒₛₜ, then the processor accepts the workload at the adapter (block 620) and returns to block 602 to determine whether an exit condition exists.

It is possible to choose several thresholds and use probabilistic acceptance of workload, as described for the target metric algorithm. Also, while response time is the metric of the preferred embodiment, it is possible to choose other criteria, such as CPU utilization for instance, to balance the load between the adapter and the host processor.

3.2. Extensions to the Preferred Embodiment

One may consider an offset between the compare metric thresholds such that one resource accepts more work than another. For example, a dedicated adapter may be allowed to have a greater response time, since the host might have a variable workload.

4. Feature Offload

As illustrated above, the target metric and compare metric algorithms may be used for bottleneck avoidance with full offload. However, both the target metric and compare metric algorithms are applicable to the feature offload case. In this case, instead of deciding whether to accept the entire work or not, a finer level of decision may be made to accept a portion of a connection's workload. In doing so, the mechanism may account for precedence constraints in features that compose the workload. For example, it may not be possible to accept feature A and/or B only without accepting feature C and D due to the nature of the workload. With these constraints, it is possible to decide which features to accept at the adapter and which features to pass on to host or other adapters.

Thus, the present invention solves the disadvantages of the prior art by providing a bottleneck avoidance mechanism for limiting the amount of workload that an intelligent adapter accepts. Thus, the adapter may avoid a state where the adapter processor is overloaded. Furthermore, the present invention provides a migration mechanism for migrating workload from an intelligent adapter to a host processor or another adapter. Thus, the adapter may efficiently operate in a fully offloaded state until the adapter becomes overloaded. If the adapter becomes overloaded, the workload may be balanced between the adapter and another processor, such as the host processor.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. For example, the bottleneck avoidance mechanism of the present invention may be used to balance workload between two adapters or among several adapters and host processors. The embodiment was chosen and described in order to best explain the principles of the invention, the practical application, and to enable others of ordinary skill in the art to understand the invention for various embodiments with various modifications as are suited to the particular use contemplated.

1. A method for bottleneck avoidance in an adapter, the method comprising:
receiving workload at an adapter connected to a host, wherein the adapter includes adapter memory and an adapter processor and wherein the host includes a host processor;
determining whether the adapter is a bottleneck;
responsive to a determination that the adapter is a bottleneck, refusing the workload; and
responsive to a determination that the adapter is not a bottleneck, accepting the workload for processing by the adapter.

2. The method of claim 1, wherein the step of determining whether the adapter is a bottleneck includes:
determining whether adapter memory usage exceeds a first threshold.

3. The method of claim 1, wherein the step of determining whether the adapter is a bottleneck includes:
determining whether adapter processor usage exceeds a second threshold.

4. The method of claim 1, wherein the step of determining whether the adapter is a bottleneck includes:
determining whether a response time for the adapter exceeds a response time for the host.

5. The method of claim 1, further comprising:
determining whether the adapter is overloaded; and
responsive to a determination that the adapter is overloaded, migrating workload from the adapter to the host.

6. The method of claim 5, wherein the step of determining whether the adapter is overloaded includes:
determining whether adapter processor usage exceeds a third threshold.

7. The method of claim 5, wherein the step of determining whether the adapter is overloaded includes:
determining whether a response time for the adapter exceeds a response time for the host by a fourth threshold.

8. The method of claim 1, wherein the adapter is a network interface.

9. The method of claim 8, wherein the workload includes network protocol processing.

10. The method of claim 8, wherein the network interface is capable of full network protocol offload.

11. The method of claim 1, wherein the step of accepting the workload for processing by the adapter includes accepting the workload based on a probability distribution function.

12. A data processing system, comprising:
a host processor;
a network interface, connected to the host processor, wherein the network interface performs network protocol processing for the host processor, wherein the network interface includes an interface memory and a network processor, and wherein the network interface receives workload, determines whether the network interface is a bottleneck, refuses the workload responsive to a determination that the network interface is a bottleneck, and accepts the workload for processing by the network processor responsive to a determination that the network interface is not a bottleneck.

13. The data processing system of claim 12, wherein the network interface determines whether the network interface is overloaded and migrates workload from the network interface to the host processor responsive to a determination that the network interface is overloaded.

14. The data processing system of claim 12, wherein the network interface is capable of full network protocol processing offload.

15. The data processing system of claim 12, wherein the network interface is capable of partial network protocol processing offload.

16. A computer program product, in a computer readable medium, for bottleneck avoidance in an adapter, the computer program product comprising:
instructions for receiving workload at an adapter connected to a host, wherein the adapter includes adapter memory and an adapter processor and wherein the host includes a host processor;
instructions for determining whether the adapter is a bottleneck;
instructions, responsive to a determination that the adapter is a bottleneck, for refusing the workload; and
instructions, responsive to a determination that the adapter is not a bottleneck, for accepting the workload for processing by the adapter.

17. The computer program product of claim 16, wherein the instructions for determining whether the adapter is a bottleneck include:
instructions for determining whether adapter memory usage exceeds a first threshold.

18. The computer program product of claim 16, wherein the instructions for determining whether the adapter is a bottleneck include:
instructions for determining whether adapter processor usage exceeds a second threshold.

19. The computer program product of claim 16, wherein the instructions for determining whether the adapter is a bottleneck include:
instructions for determining whether a response time for the adapter exceeds a response time for the host.

20. The computer program product of claim 16, further comprising:
instructions for determining whether the adapter is overloaded; and
instructions, responsive to a determination that the adapter is overloaded, for migrating workload from the adapter to the host.

21. The computer program product of claim 20, wherein the instructions for determining whether the adapter is overloaded include:
instructions for determining whether adapter processor usage exceeds a third threshold.

22. The computer program product of claim 20, wherein the instructions for determining whether the adapter is overloaded include:
instructions for determining whether a response time for the adapter exceeds a response time for the host by a fourth threshold.

23. The computer program product of claim 16, wherein the adapter is a network interface.

24. The computer program product of claim 23, wherein the workload includes network protocol processing.

25. The computer program product of claim 23, wherein the network interface is capable of full network protocol offload.

26. The computer program product of claim 16, wherein the workload is accepted based on a probability distribution function.
